(19) United States
(12) Patent Application Publication
(10) Pub. No.: US 2008/0078278 A1
(43) Pub. Date: Apr. 3, 2008

(54) BELL ENSEMBLE

(75) Inventor: Jacob H. Malta, New Britain, PA (US)

Correspondence Address: GREGORY J. GORE, 70 WEST OAKLAND AVENUE, SUITE 316, DOYLESTOWN, PA, 18901, US

(73) Assignee: MALMARK, INC., Plumsteadville, PA (US)

(21) Appl. No.: 11/533,427

(22) Filed: Sep. 20, 2006

(51) Int. Cl. G10D 13/08; G10K 1/10

(52) U.S. Cl. 84/406; 116/169

(57) ABSTRACT

A bell ensemble includes individual bells affixed to one of two parallel rails of a support framework. In keyboard fashion, a series of bells representing natural-pitched notes of a musical scale (white piano keys) extends forwardly from the front rail while extending from a second rearward rail are those bells corresponding to the sharps or flats (black piano keys). In order to position the bells for greatest ease of striking by the musician, the rear framework support rail is offset upwardly relative to the front rail to place them closer to the musician. The framework is preferably held by a freestanding support such as a cymbal stand well-known in the percussion instrument arts.

### FIELD OF THE INVENTION

The present invention relates to musical instruments and more particularly to bells which are struck by hand using a suitable element such as a mallet or a stick.

### BACKGROUND OF THE INVENTION AND DESCRIPTION OF THE PRIOR ART

It is known in the bell ringing arts for compact assemblies such as standing bell towers to be employed for striking with a suitable element such as a mallet. An example of such a bell tower is disclosed in U.S. Pat. No. 4,154,135 issued to Haack. According to this patent, flexibly mounted, freely hung bells with the frequency of the individual bells are arranged in a format such as that of a keyboard or xylophone. The bells representing the sharps and flats in the musical scale occupy a separate row located above a row of bells corresponding to sequential natural-pitched notes of a musical scale. A severe limitation of the bell arrangement shown in the Haack patent is that it is not very compact and cannot be incorporated into the other percussive instrumentation played by a single musician, for example, a drummer playing from a seated position in front of a set of drums, cymbals, and other percussive instruments.

It is therefore the object of the present invention to provide a bell instrument having the sound qualities of bells but which may be compactly and adaptably employed in a grouping of other percussive sounding elements so that a single percussionist can play the bells along with other instruments.

### SUMMARY OF THE INVENTION

In order to meet the needs in the art and achieve the objects of the invention, the present bell ensemble has been devised. The arrangement and construction of the bell ensemble is made possible by the discovery and realization that bells which are sounded by striking with a hand implement such as a mallet or a drum stick can provide the tonal qualities unique to bells without requiring that the bells be freely hung. According to the invention they are in fact substantially rigidly secured to a support framework. Furthermore, as disclosed herein, an entire chromatic octave of bells may be compactly arranged and presented to the musician for playing in an adjustable and a positionally adaptive manner. Thus, the invention is convenient to use with a group of other percussive elements such as cymbals and drums played by the same musician. To further achieve this, the present bell ensemble includes a supporting framework held by the arm of an adjustable freestanding support which provides both height and angular positioning of the bell framework in both the vertical and lateral planes.

In accordance with the bell ensemble of the invention, the individual bells are fixed to one of two parallel rails in the support framework. In keyboard fashion, a series of bells representing natural-pitched notes of a musical scale (white piano keys) extends forwardly from the front rail while extending from a second rearward rail are those bells corresponding to the sharps or flats (black piano keys). In order to position the bells for greatest ease of striking by the musician, the rear framework support rail is offset upwardly relative to the front rail to place them closer to the musician. The framework is preferably held by a freestanding support such as a cymbal stand well-known in the percussion instrument arts. This permits the bell ensemble to be easily positioned on the floor anywhere the percussionist desires. Furthermore, it allows the stand to be adjusted in height and also angled in the vertical plane by utilizing the rotatable support arm of the stand which may be releasably locked in various positions. These mechanical relations are all made possible by the substantially rigid affixation of the individual bells to the framework rails. This compactness and adjustability would not be possible if the bells were freely hung as in the prior art.

More specifically, the applicant has invented a bell ensemble comprising a framework of two elongate parallel rails, a front rail, and a rear rail. A plurality of bells are each substantially rigidly affixed to one of the rails by a fastener passing through an axial mounting hole at the top of each bell. The bells lie in a coplanar row along each rail. The rows of bells affixed to the rear rail lie in a plane above the plane of the row of bells affixed to the front rail. The rear rail is offset upwardly relative to the front rail. A stand is affixed to the framework and holds the bells in a playing position at an angle from vertical. The stand includes a support arm to which the framework is directly connected, and means for selectably adjusting the angular position of the framework and the bells in a vertical plane occupied by the support arm of the stand. The framework also includes angled sidebars interconnecting the front rail and the rear rail. The bells are tuned and positioned in a keyboard arrangement wherein the front row of bells represents natural-pitched notes of a musical scale that extend forwardly from the front rail while the bells extending from the rear rail correspond to the sharps or flats between the notes of the bells on the front rail.

From the following drawings and description of the preferred embodiment, it will be appreciated by those of skill in the art that the objects of the invention have been achieved. While the present invention will be described with the reference to a specific embodiment, the following description is illustrative of the invention and is not to be construed as limiting the invention. Various modifications to the present invention can be made to the preferred embodiment by those skilled in the art without departing from the true spirit and scope of the invention. It will be noted here that for better understanding like components are designated by the same reference numerals throughout the various figures of drawing which follow.

### BRIEF DESCRIPTION OF THE DRAWINGS

FIG. 1 is a top front left isometric view of the bell ensemble of the present invention.

FIG. 2 is a top plan view thereof.

FIG. 3 is a left side elevation view.

FIG. 4 is an elevation sectional view taken from FIG. 3 as shown in that figure.

### DESCRIPTION OF THE PREFERRED EMBODIMENT

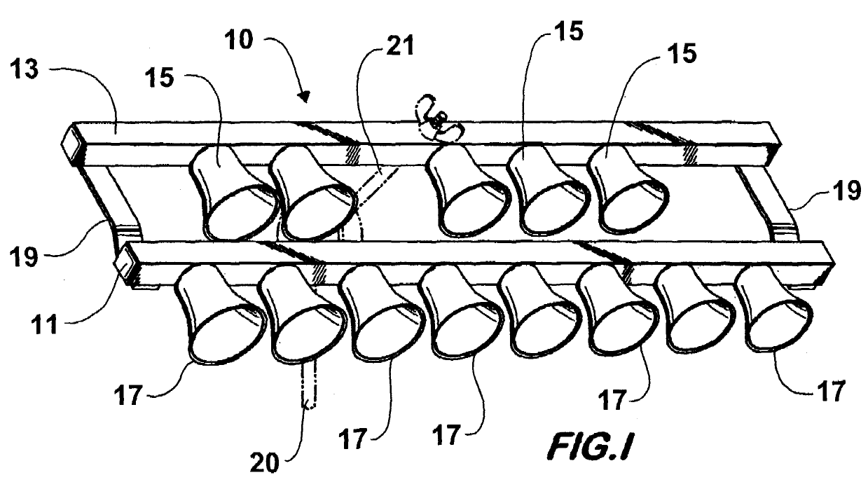

Referring now to FIG. 1, the present invention comprises two rows of bells affixed to a framework 10 either on a front rail 11 or on a rear rail 13. The bells are constructed to produce different tonal frequencies, each representing a different note of the musical scale. The rear row of bells 15 is positioned relative to the front row of bells 17 which extend forwardly from the front rail 11 in keyboard fashion as explained above and as depicted in FIG. 1. In order to more conveniently position the row of bells extending from the rear rail, the rail is held offset upwardly from the front rail which position is structurally provided by angled sidebars 19 that interconnect the front and rear rails. The bell ensemble of the invention is supported by a stand 21 of the type known in the percussion arts such as a cymbal stand which includes an extendable vertical support rod 20.

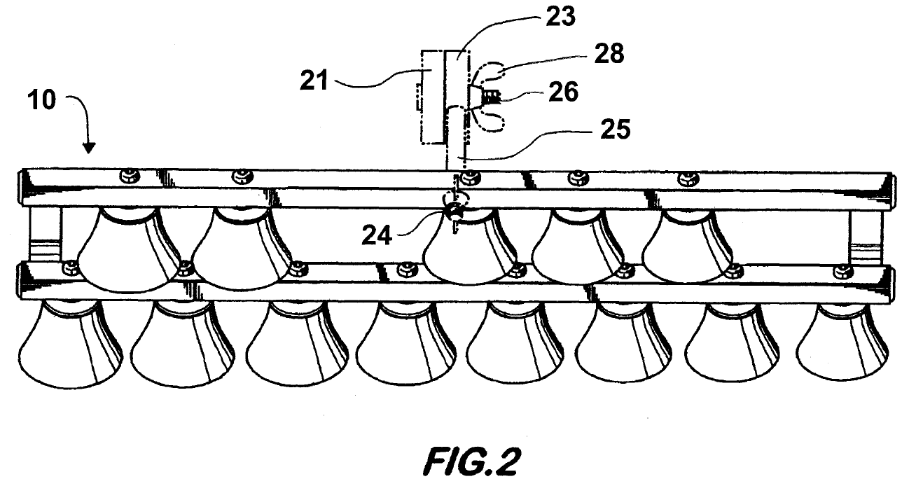

Referring now to FIG. 2, the bell framework is rigidly affixed to the end of support arm 25 of the stand. The stand also includes a means 23 for releasably locking a support arm 25 in various angular positions within a vertical plane occupied by said support arm so that the bells of the ensemble and the position of the support frame 10 may be selectively adjusted. The framework is affixed to the end of the support arm by wing nut 24 and the rotation adjustment means of the support arm includes threaded member 26 and wing nut 28 which secure the support arm in a fixed position.

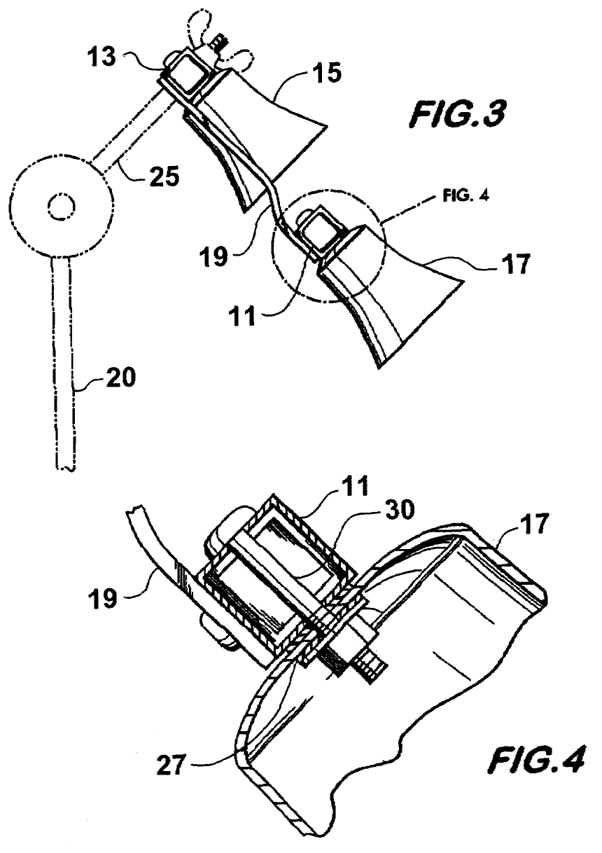

Referring now to FIG. 3, greater detail of the stand which includes vertical support rod 20 and support arm 25 is shown. Also, the offset provided by angled sidebar 19 is further depicted. Owing to these structural relations, the rear rail 13 is held upwardly, being offset from front rail 11 to position the rear row of bells closer to the musician to make them more accessible for striking.

Referring now to FIG. 4 each bell, such as the bell 17 in the front row of bells, is substantially rigidly affixed to one of the two rails, in this case rail 11. Each bell is affixed to one of the rails by a fastener 30 passing through an axial mounting hole in the top of each bell. In this case the fastening means are a nut and bolt assembly which includes elastomeric washers 27 on either side of the mounting hole at the top of the bell.

Thus it will be appreciated that the object of the invention has been achieved to provide a highly compact and adjustable bell ensemble. Because the bells are rigidly affixed they can be positioned very close to one another side-by-side and also very close above and below, thus greatly reducing the overall size of the ensemble while providing a full chromatic octave of bell tones. This would not be possible if the bells were freely hung as in the prior art because they would knock into each other if spaced so closely and would hang downwardly if tilting the framework were attempted.

It should be understood that there may be other modifications and changes to the present invention that will be obvious to those of skill in the art from the foregoing description, however, the present invention should be limited only by the following claims and their legal equivalents.

What is claimed is:

1. A bell ensemble, comprising:
a framework comprising two elongate parallel rails, a front rail, and a rear rail;
a plurality of bells each substantially rigidly affixed to one of said rails and each lying in a coplanar row along each rail; and
a stand affixed to said framework holding said bells in selective positions from vertical through any angle from vertical.

2. The bell ensemble of claim 1 wherein the rows of said bells affixed to said rear rail lie in a plane above the plane of the row of bells affixed to said front rail.

3. The bell ensemble of claim 1 wherein the stand includes a support arm to which the framework is directly connected.

4. The bell ensemble of claim 3 wherein said stand includes means for selectably adjusting the angular position of said framework and said bells in a vertical plane occupied by the support arm of said stand.

5. The bell ensemble of claim 4 wherein each bell is affixed to one of the framework rails by a fastener passing through an axial mounting hole at the top of each bell.

6. The bell ensemble of claim 3 wherein the rear rail is offset upwardly relative to said front rail.

7. The bell ensemble of claim 6 wherein said framework includes angled sidebars interconnecting said front rail and said rear rail.

8. The bell ensemble of claim 1 further including a piano keyboard arrangement of bells wherein the front row of bells represents sequential natural-pitched notes of a musical scale that extend forwardly from the front rail while the bells extending from the rear rail correspond to the chromatic notes between the notes of the bells on the front rail.
